(19) United States
(12) Patent Application Publication
(10) Pub. No.: US 2007/0001581 A1
(43) Pub. Date: Jan. 4, 2007

(54) Nanostructure based light emitting devices and associated methods

(76) Inventors: James William Stasiak, Corvallis, OR (US); Gregory Herman, Corvallis, OR (US); Paul J. Benning, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/170,551

(22) Filed: Jun. 29, 2005

(51) Int. Cl. H01J 1/62

(52) U.S. Cl. 313/498

(57) ABSTRACT

A light emitting device can incorporate a plurality of nanostructures in a light emission layer. The device can include a donor electrode and an acceptor electrode which are light transmissive. At least one of the donor electrode and acceptor electrode can include an inorganic material. The light emission layer can be disposed between each of the donor material and the acceptor material.

### FIELD OF THE INVENTION

The present invention relates generally to formation of electronic devices. More particularly, the present invention relates to light emitting devices using nanomaterials as a light emitting material and associated methods for production of such devices.

### BACKGROUND OF THE INVENTION

Quantum dots and other nanomaterials have recently spurred a great deal of interest in a wide variety of scientific and commercial applications. Nanomaterials tend to have unique properties which can make them suitable for a number of applications ranging from medical devices and treatments, to abrasive tools, to electronic devices. One area of particular interest is the development of light emitting diodes (LEDs) containing quantum dots. These efforts have primarily utilized and endeavored to improve organic-based structures. These organic LEDs (OLEDs) typically include a layer of quantum dots in an organic host layer which is sandwiched on either side with organic thin films, i.e. electron and hole transport layers. Unfortunately, these OLEDs incorporating quantum dots have limitations which reduce their commercial potential. For example, the organic layers can tend to degrade over time and are susceptible to thermal damage and erosion due to light or exposure to other materials. Further, the electronic properties of many organic materials are difficult to tune and modify making it difficult to design and to optimize the performance of the light emission layer. A number of methods have been explored to improve performance associated with such LEDs.

Each of the above methods has disadvantages which limit their effectiveness, such as expense, reliability, and complexity. For this and other reasons, the need still exists for improved LEDs having increased performance and application options which have decreased manufacturing costs, allow for a wider variety of substrate materials, and which have improved reliability.

### SUMMARY OF THE INVENTION

It has been recognized that it would be advantageous to develop improved light emitting devices and methods for forming light emitting devices. In accordance with one aspect of the present invention, a light emitting device can include a donor electrode which is light transmissive. Similarly, an acceptor electrode can also be light transmissive. At least one of the acceptor and donor electrodes can include an inorganic material. A light emission layer can be disposed between each of the donor material and the acceptor material. In particular, the light emission layer can include a plurality of nanostructures.

Additional features and advantages of the invention will be apparent from the following detailed description, which illustrates, by way of example, features of the invention.

### BRIEF DESCRIPTION OF THE DRAWING

Aspects of the invention can be better understood with reference to the following drawing. The components in the drawing are not necessarily to scale, with emphasis instead being placed upon clearly illustrating the principles of the present invention.

FIG. 1 illustrates a side cross-sectional schematic view of a light emitting device formed in accordance with an embodiment of the present invention.

### DETAILED DESCRIPTION OF THE PREFERRED EMBODIMENT(S)

Reference will now be made to exemplary embodiments and specific language will be used herein to describe the same. It will nevertheless be understood that no limitation of the scope of the invention is thereby intended. Alterations and further modifications of the inventive features described herein, and additional applications of the principles of the invention as described herein, which would occur to one skilled in the relevant art and having possession of this disclosure, are to be considered within the scope of the invention. Further, before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “an inorganic layer” includes reference to one or more of such layers and reference to “a nanostructure” includes reference to one or more of such materials.

As used herein, “light transmissive” is used to describe a material which allows light to transmit through the material. Light transmissive materials can be either translucent or transparent, and colored or clear.

As used herein, “light” is intended to include electromagnetic energy such as visible light, ultraviolet light, and infrared light.

As used herein, “transparent” is used when describing a material which allows light to transmit through the material substantially undiffused. Further, transparent materials can be colored such that an image perceived therethrough can be colored and undiffused in terms of image acuity and clarity. In contrast, a translucent material diffuses light which passes therethrough. Typically, this results in a distorted or diffuse image or light pattern.

As used herein, “matrix material” refers to a material which can be used to distribute and retain nanostructures. Preferably, the matrix material does not interfere with formation of excitons within the light emission layer during operation of the device and in most cases can contribute to the performance of the nanostructures. Suitable matrix materials can be polymeric or inorganic materials. Non-limiting examples of such materials can include polystyrenes, polycarbonates, polyacrylates, inorganic oxides, amorphous semi-conductors, and the like.

As used herein, “aspect ratio” refers to the ratio of the longest dimension to the shortest dimension of a nanostructure. Therefore, an increase in aspect ratio would indicate that the longest dimension has increased in ratio compared to the shortest dimension.

As used herein, “nanostructure” refers to any particle or structure in which at least one physical dimension is in the nanometer range. Generally, the nanometer range can be from about 0.1 nm to about 100 nm, and in some cases from about 0.1 nm to about 50 nm. Further, nanostructures suitable for use in embodiments of the present invention can have a size which is sufficient to allow the nanostructure to emit light having a particular frequency, e.g. a narrow bandgap.

As used herein, “consolidating” includes any process which is capable of decreasing porosity and/or improving the electrical and mechanical integrity of the material. Typical consolidation processes can include annealing, sintering, cold or hot isostatic pressing, and other similar processes.

As used herein, “all-additive” refers to a process in which materials are arranged and formed into electronic components without subsequent material removal steps. This is in contrast to conventional semiconductor fabrication methods which entail deposition of material followed by selective removal of portions of the material using photolithographic or other mask-type techniques, i.e. subtractive processes. Thus, all-additive processes can result in reduced waste material and fewer processing steps.

As used herein, forming one material “on” a second material includes actual physical contact or contact via an intermediate layer. For example, a light emission layer formed on an electrode can include forming the light emission layer in direct contact with an intermediate tunneling layer which is in direct contact with the electrode.

As used herein, “ink-jetting” refers to the well known process of depositing liquids using ink-jet architecture, and is in no way limited to depositing inks or ink-containing compositions, i.e., compositions containing a colorant. Common suitable ink-jet architectures include thermal ink-jet and piezoelectric ink-jet printheads. Further, ink-jetting of materials on a substrate can include direct contact of such material with the substrate or can indicate that the material is printed indirectly on the substrate by contact with a separate material or layer. Ink-jetting of materials can be an additive process.

As used herein, “vapor deposition” refers to a process of depositing materials on a substrate through the vapor phase. Vapor deposition processes can include any process such as, but not limited to, chemical vapor deposition (CVD) and physical vapor deposition (PVD). A wide variety of each vapor deposition method can be performed by those skilled in the art. Examples of vapor deposition methods include hot filament CVD, rf-CVD, laser CVD (LCVD), metal-organic CVD (MOCVD), sputtering, thermal evaporation PVD, ionized metal PVD (IMPVD), electron beam PVD (EBPVD), reactive PVD, atomic layer deposition (ALD) and the like.

As used herein, “solution phase deposition” refers to a process of depositing materials on a substrate via a liquid phase. A number of solution phase deposition processes can be suitable. Non-limiting examples can include roll coating, gravure coating, spin coating, dip coating, spray coating, extrusion coating, and the like.

As used herein, “matching” of bandgaps refers to a design consideration wherein the bandgaps of p- and n-type materials and the nanostructure light emission layer are chosen and adjusted to achieve at least partial overlap thereof to form a functional device. Although the p- and n-type material can be adjusted to some degree, the nanostructures can offer significant latitude in adjustment to allow a greater degree of freedom in choosing p- and n-type materials.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

It is to be understood that the various features shown in the attached figure is for the purposes of illustration and do not in any manner limit the present invention. In particular, structures or layers are represented in the figure by cross-hatch or dot markings. These markings are used to differentiate layers, and are not to be construed to limit the invention to any particular type of material, even in the case where the type of markings used may correspond to markings used by those in various fields of endeavor to indicate a type of material.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 500 should be interpreted to include not only the explicitly recited limits of 1 and about 500, but also to include individual values such as 2, 3, 4, and sub-ranges such as about 10 to 50, about 20 to 100, etc.

In accordance with embodiments of the present invention, a light emitting device can include a light emission layer containing a plurality of nanostructures disposed between a donor electrode and an acceptor electrode. Additional optional layers such as conducting layers, substrates, packaging layers, and phosphor layers can also be included. The light emitting devices of the present invention can be entirely light transmissive such that transparent displays and the like can be formed. Each of these layers can be formed of a number of different materials which can be chosen based on factors which depend on the composition of each layer as discussed in more detail herein. Further, these layers can be formed using any number of processes such as ink-jet printing, screen printing, spin coating, vapor deposition processes, and the like as discussed in more detail below.

Light Emitting Devices

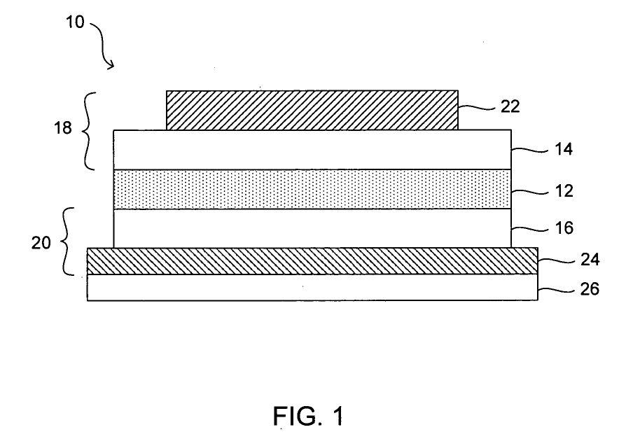

Referring now to FIG. 1, a light emitting device is shown generally at 10. In the embodiment shown, a light emission layer 12 can be disposed between each of a donor material 14 and an acceptor material 16. Further, at least one of the donor material and acceptor materials can be an inorganic material. In accordance with embodiments of the present invention, the light emission layer can include a plurality of nanostructures. Certain classes of nanostructures having specific shapes and being formed of select materials can exhibit electroluminescence upon interactions with electron-hole pairs. Electrons provided from an electron donor region such as the donor electrode can combine with holes, e.g., empty valence positions, supplied from an electron accepting region such as the acceptor electrode. When electrons and holes combine, a new quasiparticle known as an exciton is formed. Exciton formation and resulting radiative recombination within the nanostructure can cause electroluminescence of the material. However, exciton formation near a nanostructure can also result in electroluminescence via induced formation of excitons within the nanostructures or other multi-step processes, e.g. Forster transitions. The composition and geometry of the nanostructure can largely determine whether electroluminescence occurs and what frequency of light is produced.

Generally, almost any nanostructure which exhibits electroluminescence can be useful in practicing embodiments of the present invention. However, examples of suitable materials which can be used to form nanostructures can include, but are not limited to, CdSe, ZnS, InP, PbSe, PbS, InN, GaN, Si, Ge, and mixtures thereof. In one specific aspect, the nanostructure can comprise CdSe. As a general matter, non-limiting examples of suitable nanostructure materials which can be used in the light emission layer can include elements and compounds formed from Groups II and VI such as ZnO, ZnS, ZnSe, ZnTe, CdS, CdSe, CdO, CdTe, MgS, MgSe, MgTe, CaS, CaSe, CaTe, SrS, SrSe, SrTe, BaS, BaSe, and BaTe; elements and compounds formed from Groups III and V such as GaAs, InGaAs, InP, InAs, GaSb, InSb, and GaP; and other materials such as Cu₂S, FeSi₂, can also be suitable for use in various embodiments of the present invention. Further, optionally, Group IV semiconductors such as germanium, silicon, and carbon (nanodiamond) can also be used. In some embodiments, the nanostructures can comprise a material such as CdS, CdSe, CdTe, ZnS, InP, PbSe, ZnO, InAs, InGaAlAs, Si, and mixtures or combinations thereof.

In addition to the composition, the geometry of the nanostructures can also affect the emissive properties and performance of the device. Suitable nanostructures can include, but are in no way limited to, quantum dots, nanorods, nanowires, tetrapods, nanodiscs, nanoplates, nanotubes, nanocubes, core-shell structures, and combinations thereof. Although quantum dots, e.g. having an aspect ratio of about 1:1, can be a relatively effective and are readily commercially available, other non-spherical nanostructures can also be used. For example, tetrapods and other nanostructures having protrusions or similar surface irregularities can provide improved performance. Without being bound to any particular theory, it is thought that non-spherical nanostructures can act as a wire to help direct electrons and holes to the nanostructure and increase the probability that excitons are formed within the nanostructures. Nanostructures having an aspect ratio greater than about 2:1, such as from about 2:1 to about 50:1, and in some aspects from about 2:1 to about 10:1, can be beneficial in realizing improved exciton formation.

In yet another aspect of the present invention, combinations of various shapes can help to tune the emission wavelength and further optimize the electrical and optical properties of the device. For example, combinations a multiple nanostructure shapes and sizes can be used to obtain various hues, e.g, red, green, blue, yellow, and combinations thereof, or white light. Additionally, combinations of various shapes can allow for increased packing densities or packing arrangements which improve exciton formation. As a non-limiting example, nanowires, quantum dots, and tetrapods can be mixed to form a light emission layer.

Nanostructures useful in various embodiments of the present invention have a wide variety of unique properties. Most nanostructures have anisometric properties, e.g. thermal and electrical conductivity. Thus, in one alternative aspect, the nanostructures can be anisotropic. Methods of synthesizing and forming such nanostructures are well known to those skilled in the art, although future developments are likely to produce additional methods. An excellent survey of current methods of synthesizing nanostructures can be found in Y. Xia et al., One-Dimensional Nanostructures: Synthesis, Characterization, and Applications, Adv. Mater. 2003, 15, No. 5, 353-389, which is hereby incorporated by reference.

Optionally, the nanostructures can be composite nanostructures having coatings, surface modification, and/or other composite compositions. For example, one class of particularly suitable nanostructures includes core-shell nanostructures having a core material and a second coating material. In connection with this embodiment of the present invention, a number of core-shell combinations and configurations can be designed to achieve a desired emission frequency. Typically, the outer shell or a coating layer can be a material having a relatively wider bandgap and/or a suitable oxide. In one specific embodiment, the core-shell nanostructure can be a CdSe core-ZnS shell nanostructure such as those produced in accordance with known methods. Additionally, nanostructures can be coated with a capping layer such as tri-n-octylphosphine (TOPO), oleic acid, or the like. For example, PbSe quantum dots can be capped using oleic acid. An overview of one core-shell fabrication method and surface modification for passivation purposes can be found in B. O. Dabbousi et al., (CdSe)ZnS Core-Shell Quantum Dots: Synthesis and Characterization of a Size Series of Highly Luminescent Nanocrystallites, J. Phys. Chem. B, 1997, 101, pp. 9463-9475, which is incorporated herein by reference.

The dimensions of the nanostructures can also be chosen to achieve emission of a particular wavelength. One advantage of using nanostructures is the ability to adjust the energy level to match the adjacent p- and n-type layers. This advantage allows an increased flexibility in adjusting the properties of the light emission layer to match the bandgap of the p- and n-type materials on either side. For example, PbSe quantum dots having an average diameter from about 2 to 10 nanometers emit light in range from about 1 to 2 microns. Similarly, in some embodiments of the present invention, the nanostructure can be designed such that light is emitted in the infrared or ultraviolet wavelengths, and substantially not in the visible ranges. Although suitable nanostructure dimensions can vary, depending on the material, typical size ranges are from about 0.1 nm to about 20 nm, and preferably from about 0.5 nm to about 9 nm. Additionally, the electroluminescence of nanostructures is most often at a very narrow emission spectrum, e.g., less than about 3 microns.

In an additional aspect of the present invention, the arrangement and modification of the surface of nanostructures can also affect the optical gap of the nanostructures to allow for increased ability to selectively tune bandgaps of the light emission layer with those of the adjacent p- and n-type layers. For example, oxygen passivation of silicon quantum dots reduces their optical gap while hydrogen passivation increases the optical gap. The above discussion and factors can be used by those skilled in the art to readily design light emission layers having a desired bandgap and emission frequency.

Typically, the plurality of nanostructures can be distributed in an organic or inorganic matrix material. The matrix material can be almost any material which is capable of holding the nanostructures and allows for the injection, transport, or recombination of excitons at or in proximity to the nanostructures. Non-limiting examples of suitable matrix materials can include those which comprise molecularly doped polymers, organic semiconductors, oxide semiconductors, semiconductor oxides, metal oxides, and combinations, derivatives or composites thereof. Specific examples of suitable matrix materials can include, but are in no way limited to, polystyrene, polyacrylates, polycarbonates, zinc oxide, tin oxide, titanium oxide, indium oxide, gallium oxide, cadmium oxide, gallium nitride, copper oxide, strontium oxide, copper sulfide, barium sulfide, zinc sulfide, zinc selenide, gallium phosphide, spin-on-glass (doped silicon dioxide), tetraethoxysilane, polysilicon, and mixtures or derivatives thereof. Additional materials can also be suitable such as materials which provide cations or anions which can be available to minimize interfacial reactions of formation of interfacial states that can limit charge transport. Organic matrix materials can be relatively convenient for purposes of manufacturing and ease of processing. However, inorganic matrix materials tend to be much more thermally stable, have increased long term reliability, and are usually more durable than comparable organic materials. In one optional embodiment, the matrix material can be substantially electrically inert. Such electrically inert matrix materials can be substantially free of dipoles, e.g., permanent dipoles.

The distribution of nanostructures in the matrix material can be either random or ordered. An ordered distribution of nanostructures can be achieved using any suitable particle placement method. Non-limiting examples of a number of suitable particle placement methods can include nano-imprint lithography, nano-sphere lithography, anodized aluminum templating, self assembly mechanisms (SAMs) such as colloidal particle SAM and Langmuir Blodgett (LB) films, and other methods which allows for placement of nanostructures in positions in accordance with a predetermined pattern.

For example, a surface can be treated to selectively attract or grow nanostructures prior to deposition. Alternatively, nano-imprinting can be used to produce a template which allows for selective placement of nanostructures within holes of the template. Removal of the template leaves a patterned arrangement of nanostructures. Similarly, pores formed in aluminum oxide layers form a template which can be used to arrange nanostructures. Regardless of the specific method utilized, an ordered distribution of nanostructures can improve control over packing density and uniformity which can improve device performance over randomly distributed nanostructures.

In some embodiments, the light emission layer can consist essentially of the plurality of nanostructures. In these embodiments, no matrix material is necessary. This configuration can be accomplished by carefully manufacturing the adjacent donor and acceptor layer to prevent electrical shorting across the light emission layer. For example, nanostructures can be placed between two control layers such as tunneling layers or blocking layers which are sufficiently thin to allow holes and electrons to be injected into the nanostructures at conventional voltages. These control layers can preferably be substantially uniform thickness and substantially free of pin holes. Such control layers can also be used in configurations having a matrix material. Control layers can be formed of a wide variety of materials. Any material which improves the probability of hole and electron recombinations to form excitons in proximity to the nanostructures can be useful. Suitable materials for use in tunneling layers can include, but are not limited to, thin oxides such as silicon oxide and other high quality materials having substantially no electron/hole traps. Similarly, blocking layers can be used which prevent holes or electrons from exiting the light emission layer prior to formation of an exciton. Specifically, an electron blocking material can be placed adjacent the light emission layer opposite the donor material such that electrons can enter the light emission layer but are largely prevented from leaving the light emission layer. Non-limiting examples of suitable materials for use in blocking layers can include TPD as an electron blocking material and Alq3 (tris-(8-hydroxyquinoline) aluminum) as a hole blocking material.

Regardless of the specific configuration of the light emission layer, the thickness of the light emission layer along the direction of the electric field can vary somewhat. For example, in some embodiments of the present invention, the light emission layer can be substantially a monolayer of nanostructures. Typically, a monolayer of nanostructures can be distributed in a matrix material. Alternatively, the light emission layer can have a thickness which allows for two to about ten nanostructures across the thickness. As a general matter, the thickness of the light emission layer can range from about 1 nm to about 100 nm, and most often from about 2 nm to about 10 nm, although other thicknesses may also be used. The light emission layers of the present embodiment can be the sole source of light from the device such that other light sources are unnecessary.

Referring again to FIG. 1, the light emission layer 12 can also be in electrical contact with each of the donor material 14 and the acceptor material 16. The donor electrode can be light transmissive and formed of a donor material. Similarly, the acceptor electrode can also be light transmissive and likewise formed of an acceptor material. Further, at least one of the donor material and acceptor material can be an inorganic material. Thus, in some embodiments, one of the electrodes can be an inorganic material and the other can be an organic material. Regardless, the acceptor material can be an electron acceptor with respect to the donor material. Specifically, some materials can be electron donating with respect to certain materials and electron accepting with respect to others. In context of the present invention, it is desirable that the donor material and acceptor material be chosen such that a sufficient number of holes and electrons are available for recombination in the light emission layer to produce excitons resulting in electroluminescence of the nanostructures.

Generally, the inorganic donor and acceptor materials can be each independently selected from materials such as, but not limited to, gallium nitride, gallium arsenide, zinc sulfide, zinc selenide, zinc oxide, tin oxide, titanium oxide, indium oxide, gallium oxide, cadmium oxide, gallium nitride, copper oxide, strontium oxide, copper sulfide, barium sulfide, zinc sulfide, zinc selenide, gallium phosphide, and combinations or composites thereof. In addition, suitable inorganic donor and acceptor materials can also comprise oxide semiconductors such as CuAlO₂, ZnO, In₂O₃, SnO₂, CuGaO₂, SrCu₂O₂, CuInO₂, CuCrO₂, CuCa_{0.05}Cr_{0.05}O₂, CuFeO₂, CuScO₂, CuScO_{2+δ}, CuYO₂, CuCa_{0.05}Y_{90.5}O₂, CuLaO₂, SrCu₂O₂, Cu₂WO₄ (triclinic), Cu₂O (cubic), Ga₂O₃, GaInO₃, TiO₂, In₄Sn₃O₁₂, In₂O₃, ZnSnO₂, Zn₂In₂O₅, MgIn₂O₄, MgO, ZnGa₂O₄, doped varieties thereof, and combinations or composites thereof.

Suitable light transmissive n-type acceptor materials can include, but are not limited to, ZnO, In₂O₃, SnO₂, Ga₂O₃, GaInO₃, CdO, TiO₂, In₄Sn₃O₁₂, ZnSnO₃, Zn₂In₂O₅, MgIn₂O₄, MgO, ZnGa₂O₄, and combinations or composites thereof. Available light transmissive p-type donor materials are currently somewhat more limited than corresponding inorganic acceptor materials. However, non-limiting examples of several suitable transparent p-type materials can include co-doped ZnO, CuAlO₂, CuI, CuYO, CuGaO₂, SrCu₂O₂, CuInO₂, CuScO₂, LaCuOS, BaCuSF, BaCuSeF, and combinations or composites thereof. In one aspect, the transparent inorganic donor material can be CuI, which experiments have shown to have high conductivity and electron mobility. Specifically, CuI has been observed to have an optical transmission above 85% in the visible range, a direct band gap of about 2.9 eV, a conductivity at room temperature of 75.2 S/cm, a carrier density of 1.30×10²⁰ cm⁻³, and a Hall mobility of 3.62 cm²/(V sec).

As mentioned earlier, at least one of the electrodes can be an organic material. Non-limiting examples of suitable organic p- and n-type materials can include tris-(8-hydroxyquinoline) aluminum (Alq3), 3-(4-biphenylyl)-4-phenyl-5-t-butylphenyl-1,2,4-triazole, porphyrins, aromatic tertiary amine compounds such as N,N′-bis(3-methylphenyl)-N,N′-bisphenyl-benzidine (TPD) and N,N′-di(naphthalene-1-yl)-N,N′-diphenyl-benzidine (NPD), hydrazones, quinacridones, styrylamines, oxadiazole derivatives, triazole derivatives, thiopyrazine oxide derivatives, benzoquinone derivatives, naphthoquinone derivatives, anthraquinone derivatives, diphenoquinone derivatives, fluorenone derivatives, polymeric materials such as polyaniline (PANI), 3,4-polyethylene dioxythiophene/polystyrene sulfonate (PEDT/PSS), poly[triphenylamine derivative] (poly-TPD), polyvinylcarbazole (PVCZ) and poly[oxadiazole derivative] (poly-OXZ), and any other organic material which can serve as either an electron transport layer or a hole transport layer.

Many materials are light transmissive to certain wavelengths of light. For example, Cu₂O is not transparent to visible light, but is transparent at some non-visible light wavelengths, and can be made partially transparent by decreasing the thickness of the layer. Thus, in some embodiments of the present invention, the acceptor and/or donor materials can comprise a material which is light transmissive only to non-visible light. However, many commercially useful products can utilize acceptor and/or donor materials which are transparent to visible light.

The thickness of each of the inorganic donor and acceptor layers can be varied to achieve a thickness which is sufficient to maintain the desired potential and to provide mechanical integrity to the device. For example, below a certain thickness which may depend on the material, insufficient electrons are available at typical operating conditions. Similarly, the mechanical integrity can be poor such that the layer may become discontinuous or easily damaged to allow shorting or reduced performance. In contrast, excessively large thicknesses can result in unnecessary production costs and waste of materials. Further, the donor and acceptor materials are typically semiconductors such that excessively thick layers can produce undesirably high electrical resistance across the layer. In addition, as mentioned herein, some embodiments of the present invention are intended for use as flexible devices. As such, each of the constituent layers should be as thin as possible to allow for flexibility without compromising durability, transparency, and performance. With these general guidelines in context, typical donor and acceptor layers can have a thickness from about 0.5 nm to about 1 μm, and most often from about 1 nm to about 200 nm, depending on the specific material and intended application.

Each of the donor material 14, acceptor material 16, and light emission layers 12 can typically be configured as substantially parallel and flat layers adjacent one another as shown in FIG. 1. As shown, the layers can typically have a substantially uniform thickness across the entire device. However, in one optional embodiment the donor, and/or acceptor materials, can include a plurality of projections distributed across a surface thereof facing the emission layer which are sufficient to enhance cathodic luminescence of the light emission layer.

Further, one or both of the donor electrode 18 and the acceptor electrode 20 can be multi-layered. More specifically, the donor electrode can include the donor material 14 as a layer and an adjacent electrically donor side conductive material 22. The donor side conductive material can be any material which is sufficiently conductive for use in directing electrons into the inorganic donor material. Non-limiting examples of suitable donor side conductive material can include, copper, silver, gold, cobalt, platinum, palladium, iridium, rhodium, osmium, iron, nickel, titanium, aluminum, stainless steel, doped-polysilicon, and combinations or alloys thereof. Other suitable conducting materials include GaN, GaSe, ITO (indium tin oxide), aluminum doped zinc oxide, SnO₂, SiC, and Bi₂S₃, and combinations or composites thereof. In some embodiments, the light emitting devices are intended to be substantially completely light transmissive. Therefore, materials such as copper can be sufficiently thin so as to allow light to pass therethrough. Typically, this corresponds to thicknesses less than about 20 nm, although thickness can vary depending on the material.

Similarly, the acceptor electrode 20 can include an electrically conductive acceptor side material 24 adjacent the acceptor material 16. Generally, many of the same materials can be used for the conductive acceptor side materials as for the donor side material. In one aspect, the conductive acceptor material can be, but is certainly not limited to, indium tin oxide, GaN, GaSe, ITO, SnO, SiC, and Bi₂S₃, and combinations or composites thereof.

Each of the conductive acceptor side material 24 and conductive donor side material 22 can be formed of any operable thickness. Typically, these layers can have a thickness from about 50 nm to about 500 nm, although other thickness can also be suitable.

In yet another aspect of the present invention, the electrodes can include additional layers. For example, multiple layers having varying bandgap and/or work functions can be provided such that electrons can be gradually stepped up or down in energy with respect to the light emission layer. In this manner, the bandgap of an outer layer can be matched with the light emission layer by providing an intermediate layer having an intermediate bandgap.

The devices, in various embodiments, can include additional layers which can be used to achieve a desired output frequency of light. For example, a phosphor layer can be included adjacent to, or in a functional proximity to, the light emission layer. At least a portion of light emitted from the light emission layer can be absorbed and converted to a different frequency of light. Thus, the additional layer can act as a down conversion or up conversion device in order to achieve a desired output frequency. White LEDs can be formed by using a light emission layer containing nanostructures which emit in the blue region. A phosphor layer can be included which can absorb a portion of the blue light and is then down converted to yellow light via a phosphor conversion process. A white light is thus emitted from such a device.

In still another aspect of the present invention, a light transmissive substrate 26 can be adjacent the conductive acceptor side material 24. Alternatively or additionally, the substrate can be placed adjacent the conductive donor side material 22. In either case, the substrate can serve as a protective coating or packaging layer. The substrate can comprise any material which is non-conducting and is light transmissive. Further, in many embodiments it is desirable for the substrate to also be flexible to provide flexibility to the entire device. Non-limiting examples of suitable substrate materials can include polycarbonate, polyester, polyethylene terephthalate, epoxy, glass, and the like.

The light emitting devices of embodiments of the present invention can be light transmissive. In this manner, the devices can be used in a variety of applications such as, but not limited to, transparent LEDs or as parts of transparent electronic circuits. Transparent LEDs can be useful in producing integrated heads up displays, immersion displays, or the like. Further, LEDs of the present invention can be designed as light emitting diodes, displays, or other light emitting devices.

In order to produce a useful display using the LEDs described above, additional components can be used to form a multi-pixel display. For example, an array of LEDs can be printed on a substrate having adjacent thin film transistors which have been printed or formed using the same methods as described herein. Each of the LEDs can be grounded at one electrode and connected to a transistor at the other electrode. Further, the transistors can be arranged along a grid of columns and rows of conductive traces. In one arrangement, each transistor can be operatively connected to an adjacent row and column line such that each transistor can be individually addressed. Specifically, in order for the transistor to function to send an electrical voltage across the LED, each of the column and row line must be turned on. In order to form an image, the columns can be sequentially addressed to cause electroluminescence of desired LEDs to form an image. In this manner, large area displays can be formed using all-additive processes such as ink-jet rapidly and inexpensively. Based on the teachings of the present description, those skilled in the art can readily design transparent displays using the LEDs described herein.

Illustrative Methods of Manufacturing

The light emitting devices, according to some embodiments, can be fabricated using a number of deposition processes. Each of the constituent layers discussed above can be formed via ink-jet printing, screen printing, solid freeform fabrication (SFF) such as stereolithography, embossing, imprint lithography, selective laser sintering, fused deposition modeling, 3D printing, and 3D ink-jet wax printing, vapor deposition such as chemical vapor deposition or physical vapor deposition, deposition and subtractive lithography, electron-beam evaporation, electroless deposition, electroplating, solution phase deposition such as roll coating, spray coating, dip coating, extrusion coating, and spin casting, combinations of these processes, or the like. Further, conventional thin film processes such as plasma etching, molecular beam epitaxy (MBE), MOCVD, atomic layer deposition, rapid thermal processing and other vapor deposition processes can be used.

Ink-jet processes can provide an inexpensive and effective way to form one or more of the layers of the present invention. Ink-jet processes can also allow for roll-to-roll (R2R) processes to be used in fabrication of large device areas and scale up for mass production. For example, an inorganic material for use in the donor and/or acceptor layers can be dispersed or otherwise mixed into a liquid vehicle to form an ink-jettable composition. The ink-jettable composition can then be placed in an ink-jet cartridge and printed on a substrate. The liquid vehicle can then be removed by evaporation or decomposition to leave a thin film of the desired material. This same basic procedure can be followed for one or more of the layers of the present invention. Using ink-jet processes on flexible plastics can be highly desirable in producing large surface areas via ink-jet (multiple heads) SFF and R2R manufacturing.

Similarly, in R2R processes, a roll of a flexible substrate such as plastic or metal foil runs through a device using rollers to define its path and maintain proper tension and position. As the substrate passes through various process stages, e.g., ink-jet printing or other deposition processes, materials can be deposited and patterns can be created. Electronic devices and components can be built up on the substrate to produce a fully-integrated device.

Typically, the entire device, or array of devices, can be formed using ink-jet processes. Referring again to FIG. 1, a flexible light transmissive substrate 26 such as a glass or plastic can be used as an external packaging layer. A large sheet of such material can be prepared and a plurality of conductive traces corresponding to the conductive layer of the acceptor electrode can be printed using ink-jet. The inorganic acceptor material can then be printed, followed by each of the light emission layer, inorganic donor material, and conductive donor side material.

In one specific embodiment, a sol-gel precursor such as zinc 2-ethylhexanoate can be mixed with isopropyl alcohol in a moisture and oxygen free environment to form an ink-jettable composition. This layer can then be thermal processed between 300° C. and 800° C. to form a ZnO thin film. Alternatively, CuI can be mixed with acetonitrile and ultrasonically agitated to form an ink-jettable composition. Regardless, the final layer can be adjusted in thickness by varying the precursor concentration, printing parameters such as speed, printer throughput, etc., and printing multiple layers.

The use of ink-jet processes in connection with embodiments of the present invention can allow for ease of implementation, design changes, and rapid turnaround times. Additionally, many of the basic components for ink-jet printing of devices are readily available and have increased manufacturing speeds and reliability as compared to conventional methods of forming electronic devices. Current ink-jet printing processes which can be used in connection with the present invention allow for LEDs and other features having a smallest dimension of about 5 μm, and typically from about 20 μm.

The light emission layer can also be formed using any of the above described methods. However, additional processes can also be suitable for deposition of the nanostructures. For example, the nanostructures can be formed into a slurry and then deposited on a surface. Alternatively, the nanostructures can be grown directly on a substrate in accordance with known processes. Additionally, the nanostructures can be distributed in the matrix material and then the mixture of matrix material and nanostructures can be formed into the light emission layer.

Alternatively, nanostructures can be suspended in an organic or inorganic binder and optional solvent. The spinning properties of the suspension such as viscosity and vapor pressure can be readily adjusted to provide useful control of the dispersion characteristics and thickness of the spin cast layer. In one specific embodiment, nanostructures can be added to a solution of chloroform and an organic semiconductor material. Once combined, the solution can be deposited by spin casting.

The method according to embodiments of the present invention can also include subtractive processes for forming various layers such as lithography, etching, or the like. Further, additive-subtractive hybrid processes can also be used. Most additive processes are performed at relatively low temperatures such as below about 200° C. However, additional subsequent post-deposition processes can be performed at somewhat higher temperatures. These low temperatures allow for use of substrates such as flexible polymers and the like. Thus, by forming each of the layers of sufficiently thin material, the entire device can be made flexible. The present invention can be highly useful in producing commercial products such as robust transparent heads up displays and flexible immersion displays. In addition, fully-inorganic devices can offer a number of commercially useful properties such as increased robustness, stability, service life, and operating temperatures.

As mentioned previously, one advantage of the present invention is the ability to adjust the bandgap of the light emission layer by adjusting the diameter of the nanostructures or choosing from among a wide variety of nanostructure materials. This allows an additional degree of freedom in designing devices in accordance with embodiments of the present invention.

Thus, not only can the inorganic donor and acceptor layers be chosen to achieve a particular bandgap, but the light emission layer can be designed to match the surrounding charge injection layers. Thus, in one aspect of the present invention, the materials of each layer can be tuned to achieve matching of the respective bandgaps.

### EXAMPLE

The following example illustrates an embodiment of the invention. It is to be understood that the following is only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while embodiments of the present invention has been described above with particularity, the following Example provides further detail in connection with what is presently deemed to be a practical embodiment of the invention.

Fabrication of an LED having a luminescent wavelength between about 470 nm and 640 nm, depending on the nanostructure size, using CdSe—ZnS core-shell nanostructures is described. A high quality (optically transparent/smooth) glass substrate with a thin transparent indium tin oxide (ITO) coating is obtained. Typical transparent ITO layer thicknesses can range from about 10 to about 500 nm, and is 100 nm in this example, which gives a resistance of about 20 Ohms/square. The bottom n-type layer consists of zinc oxide (ZnO) deposited using an rf-magnetron sputtering process. The thickness of the ZnO layer can be in the range of 100 nm to 300 nm, and is about 250 nm in this example. At this thickness, the ZnO film is transparent.

The carrier concentration of the ZnO can be adjusted using a doping procedure. In this case, the ZnO is doped with about 2% Al resulting in heavily doped n+ZnO—Al which has a conductivity of about 1800 S/cm.

A light emissive quantum dot layer is deposited on top of the doped ZnO—Al layer using a spin casting method. The nanostructures are CdSe—ZnS core-shell quantum dots which have a diameter in the range of 2.9 nm to 6.1 nm, inclusive. The CdSe—ZnS core shell quantum dots are further processed to add an additional passivation layer of trioctylphosphine oxide (TOPO) using formulation procedures that can be found in the literature. A solution of the TOPO capped CdSe—ZnS quantum dots in chloroform is prepared using a synthetic techniques described by Murray et al. (C. B. Murray, D. J. Norris, M. G. Bawendi, J. Am. Chem. Soc. 115, 8706 (1993)). The quantum dots are mixed into a solution of chloroform and N,N′-diphenyl-N,N′-bis(3-methylphenyl)-(1,1′-biphenyl)-4-4′-diamine (TPD) and spin cast onto the n+ZnO—Al layer. The viscosity of the quantum dot/TPD solution is adjusted for spin casting to produce a thickness in the range of 10 nm to 50 nm and in this example is about 40 nm. Finally, the p-type electrode is deposited onto the quantum dot/TPD layer. Copper yttrium oxide (CuYO) is deposited at low temperature (about 100° C.) using a reactive co-evaporation process. In this process, Y, Cu and Ca are thermally co-evaporated using standard thin film deposition methods. The thickness of this layer is in a range from about 100 nm to about 500 nm, and in this example is 300 nm. After deposition, the conductivity of the CuYO film can be adjusted using a rapid thermal anneal process in oxygen. Under these conditions, the carrier concentration of the CuYO film is in the range of 1×10ˆ19 cm⁻³ and exhibits about 40% to 50% transparency in the visible region of the spectrum. This simple, transparent, p-i-n heterojunction quantum dot emitter emits light at about 600 nm.

While this is a simple example, it is recognized that additional layers and process steps can be used to stabilize the device and optimize the performance.

It is to be understood that the above-referenced arrangements are illustrative of the application for the principles of the present invention. Thus, while embodiments of the present invention has been described above, it will be apparent to those of ordinary skill in the art that numerous modifications and alternative arrangements can be made without departing from the principles and concepts of the invention as set forth in the claims.

What is claimed is:

1. A light emitting device, comprising:
a) a donor electrode being light transmissive and comprising a donor material;
b) an acceptor electrode being light transmissive and comprising an acceptor material, wherein at least one of the donor material and acceptor material is an inorganic material; and
c) a light emission layer disposed between each of the donor material and the acceptor material, said light emission layer including a plurality of nanostructures.

2. The device of claim 1, wherein the nanostructures are selected from the group consisting of quantum dots, nanorods, nanowires, tetrapods, nanodiscs, nanoplates, nanocubes, nanotubes, core-shell structures, and combinations thereof.

3. The device of claim 1, wherein the nanostructures have an aspect ratio from about 2:1 to 50:1.

4. The device of claim 1, wherein the nanostructures comprise a material selected from the group consisting of CdS, CdSe, CdTe, ZnS, InP, PbSe, ZnO, InAs, InGaAlAs, silicon, and mixtures thereof.

5. The device in claim 1, wherein the surfaces of the nanostructures are coated with a capping layer.

6. The device of claim 1, wherein the nanostructure emits light in the infrared or ultraviolet wavelengths.

7. The device of claim 1, wherein the device is transparent to visible light.

8. The device of claim 1, wherein the plurality of nanostructures further comprises a plurality of shapes.

9. The device of claim 1, wherein the plurality of nanostructures are distributed in a matrix material.

10. The device of claim 9, wherein the matrix material comprises a member selected from the group consisting of molecularly doped polymers, organic semiconductors, oxide semiconductors, semiconductor oxides, metal oxides, and mixtures or derivatives thereof.

11. The device of claim 1, wherein each of the donor and acceptor materials are inorganic materials.

12. The device of claim 11, wherein the donor and acceptor materials are each independently selected from the group consisting of gallium nitride, gallium arsenide, zinc sulfide, zinc selenide, zinc oxide, tin oxide, titanium oxide, indium oxide, gallium oxide, cadmium oxide, gallium nitride, copper oxide, strontium oxide, copper sulfide, barium sulfide, zinc sulfide, zinc selenide, gallium phosphide, and combinations thereof.

13. The device of claim 1, wherein the donor material comprises a member selected from the group consisting of co-doped ZnO, CuAlO₂, CuI, CuYO, CuGaO₂, SrCu₂O₂, CuInO₂, CuScO₂, LaCuOS, BaCuSF, BaCuSeF, and combinations or composites thereof.

14. The device of claim 1, wherein at least one of the donor electrode and the acceptor electrode is a multi-layered electrode.

15. The device of claim 14, wherein the donor electrode further comprises an electrically conductive material adjacent the donor material.

16. The device of claim 15, wherein the electrically conductive material is a member selected from the group consisting of copper, silver, gold, cobalt, platinum, palladium, iridium, rhodium, osmium, iron, nickel, titanium, aluminum, stainless steel, doped-polysilicon, GaN, GaSe, indium tin oxide, aluminum doped zinc oxide, SnO₂, SiC, and Bi₂S₃, and combinations or composites thereof.

17. The device of claim 14, wherein the multi-layered electrode includes layers having an intermediate bandgap with respect to the light emission layer.

18. The device of claim 1, further comprising a first control layer between the donor material and the light emission layer and a second control layer between the acceptor material and the light emission layer.

19. The device of claim 1, wherein the light emission layer has a thickness from about 1 nm to about 100 nm.

20. The device of claim 1, wherein the device is a display device.

21. The device of claim 1, wherein the device emits white light.

22. A method of fabricating a light emitting device, comprising the steps of:
a) forming a first light transmissive electrode of a first material;
b) forming a light emission layer on the first material, said light emission layer including a plurality of nanostructures; and
c) forming a second light transmissive electrode of a second material on the light emission layer, wherein at least one of the first material and second material is an inorganic material.

23. The method of claim 22, wherein the nanostructures are selected from the group consisting of quantum dots, nanorods, nanowires, tetrapods, nanodiscs, nanoplates, nanocubes, nanotubes, core-shell structures, and combinations thereof.

24. The method of claim 22, wherein the nanostructures are non-spherical.

25. The method of claim 22, wherein the plurality of nanostructures are distributed in a matrix material.

26. The method of claim 22, wherein at least one of the donor electrode and the acceptor electrode is multi-layered.

27. The method of claim 22, wherein the step of forming the light emission layer further includes selecting the nanostructures such that a bandgap of the first and second inorganic materials matches a bandgap of the light emission layer.

28. The method of claim 22, wherein the step of forming the first electrode layer or the step of forming the second electrode layer is accomplished by ink-jet deposition.

29. The method of claim 22, wherein the step of forming the light emission layer is accomplished by spin coating.

30. The method of claim 22, wherein the step of forming the light emission layer includes forming an ordered distribution of the plurality of nanostructures.

31. The method of claim 30, wherein the ordered distribution is achieved using a particle placement method selected from the group consisting of nano-imprint lithography, nano-sphere lithography, self assembly mechanisms, and anodized aluminum templating.

32. The method of claim 22, wherein the method is an all-additive process of forming the device.

33. A device produced by the method of claim 22.

34. The device of claim 33, wherein the device is flexible.

35. The device of claim 33, wherein the device is a display device.

36. The device of claim 33, wherein the device is a light emitting diode.
